(19) United States
(12) Patent Application Publication
(10) Pub. No.: US 2023/0252771 A1
(43) Pub. Date: Aug. 10, 2023

(54) METHOD AND APPARATUS WITH LABEL NOISE PROCESSING

(71) Applicant: Samsung Electronics Co., Ltd., Suwon-si (KR)

(72) Inventors: Heewon KIM, Seoul (KR); Jihye KIM, Anyang-si (KR); Seungju HAN, Seoul (KR)

(73) Assignee: Samsung Electronics Co., Ltd., Suwon-si (KR)

(21) Appl. No.: 17/988,072

(22) Filed: Nov. 16, 2022

(30) Foreign Application Priority Data
Jan. 14, 2022 (KR) 10-2022-0006056
Apr. 5, 2022 (KR) 10-2022-0042288

(51) Int. Cl. G06V 10/776; G06V 10/82; G06N 3/04

(52) U.S. Cl. CPC G06V 10/776; G06N 3/0454; G06V 10/82

(57) ABSTRACT

A processor-implemented method with label noise processing includes: iteratively training a first model for correcting a label of a data set, the label comprising noise, and a second model for detecting the noise of the label; and processing the data set comprising the noise using either one or both of the trained first model and the trained second model, wherein the iterative training comprises: identifying clean data in the data set using the second model; training the first model using the clean data; correcting the label of the data set using the trained first model; and training the second model based on the data set comprising the corrected label.

### CROSS-REFERENCE TO RELATED APPLICATIONS

This application claims the benefit under 35 USC § 119(a) of Korean Patent Application No. 10-2022-0006056, filed on Jan. 14, 2022 with the Korean Intellectual Property Office, and Korean Patent Application No. 10-2022-0042288, filed on Apr. 5, 2022 with the Korean Intellectual Property Office, the entire disclosures of which are incorporated herein by reference for all purposes.

### BACKGROUND

### 1. Field

The following description relates to a method and apparatus with label noise processing.

### 2. Description of Related Art

The success or failure of deep learning may be determined by large-scale training data sets. Acquiring data sets with accurate labels may be expensive and/or time consuming. Data sets for training may have issues relating to label integrity and consistency.

A model trained based on a data set with noise may have difficulty in properly processing noise when a network is being trained.

There are various techniques for training a deep learning model using a dataset including label noise. A typical example may be a scheme of estimating label noise with loss function values of training samples, and there are schemes such as a scheme of weighting the loss value so that there is less impact on a data label presumed to be noise in the training process of the deep learning model, or a scheme of removing noise and performing training based on semi-supervised learning, and training only with refined data, etc.

In a typical scheme, a neural network may be trained towards reducing the loss value of a cross-entropy loss, and the label noise is estimated based on the loss value of the cross-entropy loss for each instance of each piece of data. However, accurately distinguishing actual label noise may be difficult, and the ability to distinguish between different types of heterogeneous label noise such as instance dependent noise and feature dependent noise may be significantly reduced.

In addition, in the typical scheme of removing noise and training only with refined data, the number of refined pieces of data reduces as the ratio of label noise to data increases, so achieving performance improvement may be difficult due to overfitting to a small number of pieces of data, and more difficult when the label noise is large.

### SUMMARY

This Summary is provided to introduce a selection of concepts in a simplified form that are further described below in the Detailed Description. This Summary is not intended to identify key features or essential features of the claimed subject matter, and is not intended to be used as an aid in determining the scope of the claimed subject matter.

In one general aspect, a processor-implemented method with label noise processing includes: iteratively training a first model for correcting a label of a data set, the label comprising noise, and a second model for detecting the noise of the label; and processing the data set comprising the noise using either one or both of the trained first model and the trained second model, wherein the iterative training includes: identifying clean data in the data set using the second model; training the first model using the clean data; correcting the label of the data set using the trained first model; and training the second model based on the data set comprising the corrected label.

The iterative training may include training the first model and the second model based on the data set.

The identifying of the clean data in the data set may include identifying the clean data based on a size of a difference between an output result of the second model and the label before the correcting of the label.

The identifying of the clean data based on the size of the difference between the output result of the second model and the label before the correcting of the label may include identifying the clean data based on the following equation: (ƒ^{model2}(xᵢ),yᵢ)-D_{Y|D}[(ƒ^{model2}(xᵢ),Y)] ≤ 0 wherein (ƒ^{model2}(xᵢ),yᵢ) denotes a loss for a label yᵢ corresponding to an input xᵢ input to the second model, D denotes a data set, and D_{Y|D}[(ƒ^{model2}(xᵢ),Y)] denotes a loss for the data set.

The iterative training of the first model and the second model may include iteratively training the first model and the second model a predetermined number of times.

The identifying of the clean data may include identifying, in response to the training of the second model based on the data set comprising the corrected label, the clean data in the data set using the trained second model.

The processing of the data set comprising the noise may include: inputting the data set comprising the noise to the trained first model; and determining a corrected label of the data set corresponding to the noise using the trained first model.

The processing of the data set comprising the noise may include: inputting the data set comprising the noise to the trained second model; and detecting noise in the data set comprising the noise using the trained second model.

The data set may include image data.

In another general aspect, one or more embodiments include a non-transitory computer-readable storage medium storing instructions that, when executed by one or more processors, configure the one or more processors to perform any one, any combination, or all operations and methods described herein.

In another general aspect, an apparatus with label noise processing includes: one or more processors configured to: iteratively train a first model for correcting a label of a data set, the label comprising noise and a second model for detecting the noise of the label; and process the data set comprising the noise using either one or both of the trained first model and the trained second model, wherein, for the iterative training, the one or more processors are configured to: identify clean data in the data set using the second model; train the first model using the clean data and a label corresponding to each piece of the clean data; correct the label of the data set using the trained first model; and train the second model based on the data set comprising the corrected label.

For the iterative training, the one or more processors may be configured to train the first model and the second model based on the data set.

For the identifying of the clean data in the data set, the one or more processors may be configured to identify the clean data based on a size of a difference between an output result of the second model and the label before the correcting of the label.

For the identifying of the clean data based on the size of the difference between the output result of the second model and the label before the correcting of the label, the one or more processors may be configured to identify the clean data based on the following equation: (ƒ^{model2}(xᵢ),yᵢ) - D_{Y}_{|D}[(ƒ^{model2}(xᵢ), Y)] ≤ 0 wherein (ƒ^{model2}(xᵢ),yᵢ) denotes a loss for a label yᵢ corresponding to an input xᵢ input to the second model, D denotes a data set, and _{D}_{Y|D}[(ƒ^{model2}(xᵢ),Y)] denotes a loss for the data set.

For the iterative training of the first model and the second model, the one or more processors may be configured to iteratively train the first model for correcting the label and the second model for detecting the noise of the label a predetermined number of times.

For the identifying of the clean data may include identifying, the one or more processors may be configured to identify, in response to the training of the second model based on the data set comprising the corrected label, the clean data in the data set using the trained second model.

For the processing of the data set comprising the noise, the one or more processors may be configured to: input the data set comprising the noise to the trained second model; and determining a corrected label of the data set corresponding to the noise using the first trained model.

For the processing of the data set, the one or more processors may be configured to: input the data set comprising the noise to the trained second model; and detect noise in the data set comprising the noise using the trained second model.

The data set may include image data.

The apparatus may include a memory storing instructions that, when executed by the one or more processors, configure the one or more processors to perform: the iteratively training of the first model and the second model; and the processing of the data set.

In another general aspect, a processor-implemented method with label noise processing includes: identifying clean data in a data set using a second model, the second model being for detecting noise of a label of the data set; training a first model using the clean data, the first model being for correcting the label; correcting the label using the trained first model; and training the second model based on the data set comprising the corrected label.

The identifying of the clean data may include: determining labels of the data set, including the label, using the second model; and determining the clean data and noisy data of the data set, based on the determined labels.

The method may include processing the data set comprising the noise using either one or both of the trained first model and the trained second model.

Other features and aspects will be apparent from the following detailed description, the drawings, and the claims.

### BRIEF DESCRIPTION OF THE DRAWINGS

FIG. 1 is a flowchart illustrating an example of an operating method of an apparatus with label noise processing.

FIG. 2 is a flowchart illustrating an example of a method of repeatedly training a first model and a second model.

FIG. 3 illustrates an example of a learning process of a first model and a second model.

FIGS. 4A and 4B illustrate an example of outputs of a trained first model and a trained second model.

FIG. 5 illustrates an example of a configuration of an apparatus with label noise processing.

FIGS. 6A-6D are graphs illustrating performance of an apparatus according to examples.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The terminology used herein is for the purpose of describing particular examples only and is not to be limiting of the examples. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which examples pertain and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

When describing the examples with reference to the accompanying drawings, like reference numerals refer to like constituent elements and any repeated description related thereto will be omitted. In the description of the examples, a detailed description of well-known related structures or functions will be omitted when it is deemed that such description will cause ambiguous interpretation of the present disclosure.

Although terms, such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Throughout the specification, when a component is described as being “connected to,” “coupled to,” or “accessed to” another component, it may be directly “connected to,” “coupled to,” or “accessed to” the other component, or there may be one or more other components intervening therebetween. In contrast, when an element is described as being “directly connected to,” “directly coupled to,” or “directly accessed to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

The same name may be used to describe an element included in the examples described above and an element having a common function. Unless otherwise mentioned, the descriptions of the examples may be applicable to the following examples and thus, duplicated descriptions will be omitted for conciseness.

One or more embodiments relate to a method of detecting label noise in a situation where a data label is unreliable because the data label includes noise and correcting the label noise to train a neural network model.

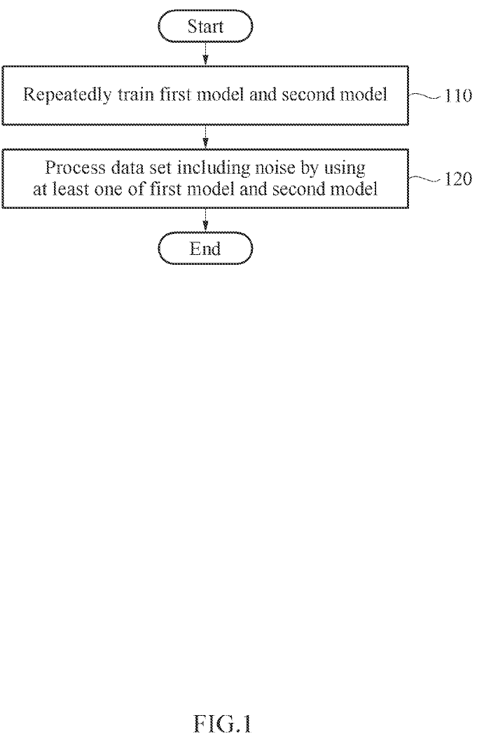

FIG. 1 is a flowchart illustrating an example of an operating method of an apparatus with label noise processing. The operations in FIG. 1 may be performed in the sequence and manner as shown. However, the order of some operations may be changed, or some of the operations may be omitted, without departing from the spirit and scope of the shown example. Additionally, operations illustrated in FIG. 1 may be performed in parallel or simultaneously. One or more blocks of FIG. 1, and combinations of the blocks, can be implemented by special purpose hardware-based computer that perform the specified functions, or combinations of special purpose hardware and instructions, e.g., computer or processor instructions.

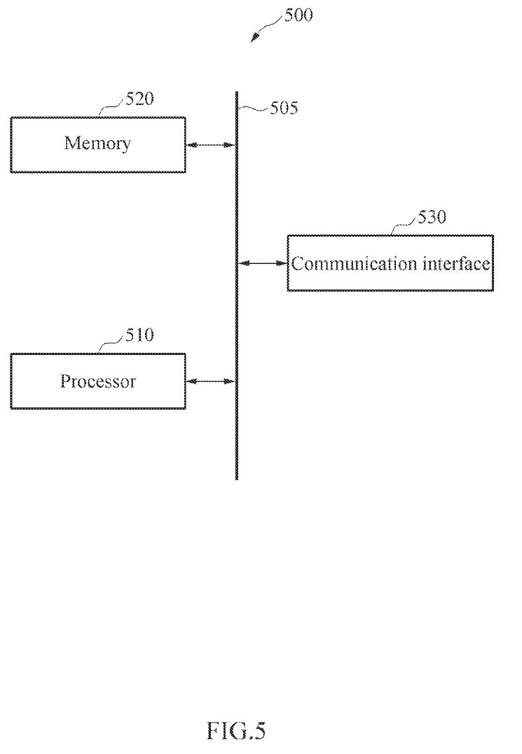

In operation 110, an apparatus with label noise processing (the apparatus 500 of FIG. 5, as a non-limiting example) may repeatedly (e.g., iteratively) train a first model for correcting a label of a data set, the label including noise, and a second model for detecting the noise of the label.

The apparatus may use two neural network models (e.g., the first model and the second model) and may generate a neural network model that detects and corrects noise from a data set including noise in a label by performing mutually different iterative training on the two models.

The first model and the second model may be pre-trained models (pre-trained through a data set including label noise) and through an iterative training process, the first model may be trained to correct a label corresponding to the noise, and the second model may be trained to detect the label noise from the data set.

A cycle of repeatedly or iteratively training the first model and the second model may be performed a predetermined number of times (e.g., N times, where N is an integer greater than or equal to 2). When the cycle has been repeated a predetermined number of times, the training of the first model and the second model may be complete.

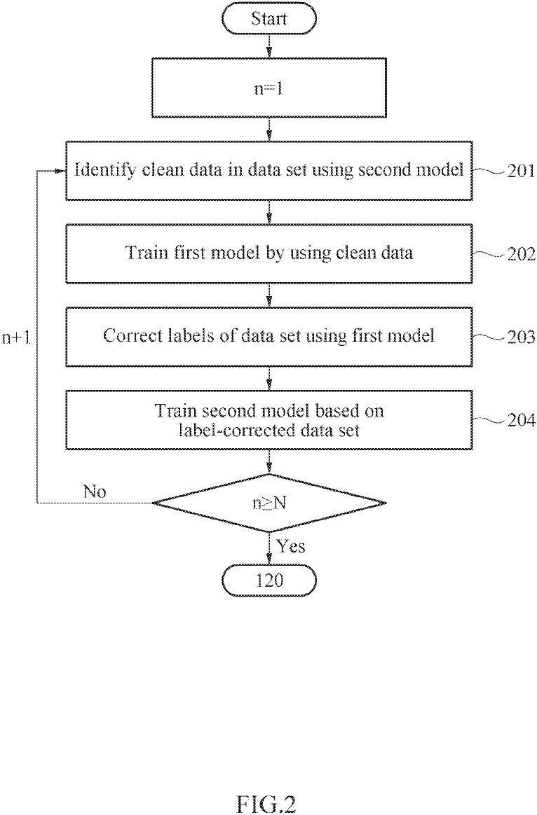

A non-limiting example method of repeatedly training the first model and the second model (operation 110 of FIG. 1, as a non-limiting example) is described in detail with reference to FIG. 2.

FIG. 2 is a flowchart illustrating an example of a method of repeatedly training a first model and a second model. The operations in FIG. 2 may be performed in the sequence and manner as shown. However, the order of some operations may be changed, or some of the operations may be omitted, without departing from the spirit and scope of the shown example. Additionally, operations illustrated in FIG. 2 may be performed in parallel or simultaneously. One or more blocks of FIG. 2, and combinations of the blocks, can be implemented by special purpose hardware-based computer that perform the specified functions, or combinations of special purpose hardware and instructions, e.g., computer or processor instructions. In addition to the description of FIG. 2 below, the description of FIG. 1 is also applicable to FIG. 2 and is incorporated herein by reference. Thus, the above description may not be repeated here for brevity purposes.

In operation 201, the apparatus may 9dentifies (e.g., determine) clean data in a data set using the second model.

The apparatus may include a noise filtering module. In operation 201, the apparatus may input the data set to the second model and input a result output from the second model, the output being generated by the second model based on the input data set, to the noise filtering module to detect or determine label noise and determine and distinguish clean data of the data set from noise data of the data set. In a non-limiting example, the second model may be or include the noise filtering module.

In operation 202, the apparatus may train the first model by using the clean data and a label corresponding to each piece of the clean data.

In operation 202, the apparatus may train the first model using the identified clean data excluding the noise data (e.g., using only the identified clean data). The first model may be trained using input data of the clean data and an initial label corresponding to the input data.

The first model may be trained on the clean data in operation 202, and the trained first model may output an appropriate label in response to the input data of the data set. The accuracy of a label output may be increased by the process of the repeated training according to the example.

In operation 203, the apparatus may correct the labels of the data set using the trained first model.

The apparatus may include a label correction module. The label correction module may be or correspond to a module for obtaining (e.g., determining) a corrected label by directly applying a label of an entire data set to the pre-trained first model. In a non-limiting example, the trained first model may be or include the label correction module.

In operation 203, the apparatus may input a data set to the trained first model and obtain a corrected label for the data set. The apparatus may match the obtained label to a corresponding instance (e.g., input) and store the obtained label as a temporary data set (e.g., a label-corrected data set).

In operation 204, the apparatus may train the second model based on the label-corrected data set.

In operation 204, the second model may be trained using the stored temporary data set (e.g., the label-corrected data set) generated based on an output of the first model. The second model may be trained based on a temporary label corrected in the same instance.

The trained second model may be used as a model for distinguishing clean data from noise in a data set.

The training process of operations 201 to 204 may be repeated. The apparatus may filter out noise from a label corresponding to an output of the second model trained through the noise filtering module, and identify clean data. The identified clean data may be used to train the first model again.

In an example, through the noise filtering module, clean data may be identified based on a size of a difference between an output result of the second model and the label before the label is corrected, and the noise filtering module for identifying the clean data may be configured. A non-limiting example of the configuration will be described in detail later.

Referring back to FIG. 1, in operation 120, the apparatus processes the data set including noise by using either one or both of the trained first model and the trained second model.

The first model may be used to infer a label and the second model may be used to detect noise in the label.

The first model that has been trained (e.g., trained the predetermined number of times) may output a corrected label in an instance corresponding to a label including noise when a data set including noise is input.

The second model that has been trained (e.g., trained the predetermined number of times) may calculate (e.g., determine) a loss from a data set including noise, and may detect a label including noise by using a loss function value of the second model.

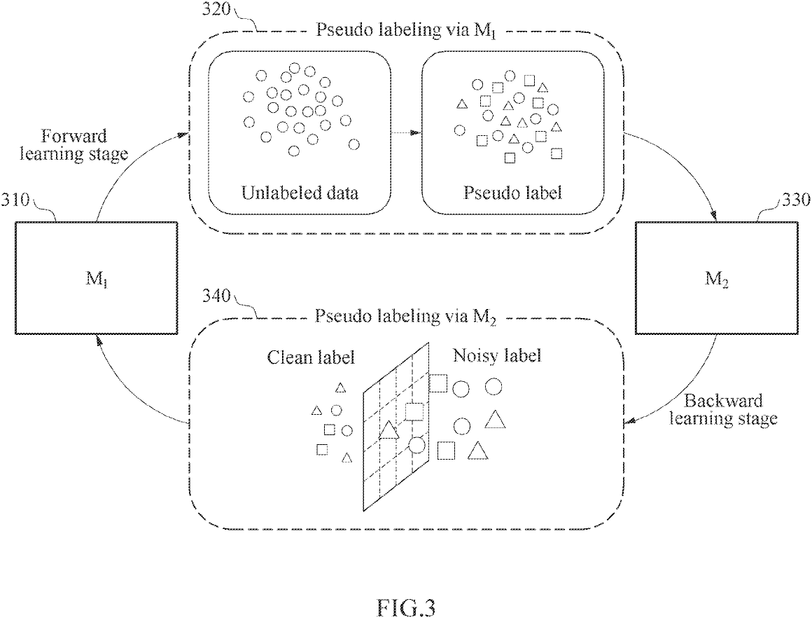

FIG. 3 illustrates an example of a learning process of a first model and a second model (e.g., the first model and the second model of FIG. 1 and/or FIG. 2).

The pre-trained first model and second model may each perform different roles, and the defects of each model may be compensated for by repeating asymmetric training by mutually exchanging each learned result.

A data set may be expressed as D:= {(xₙ, yₙ); n = {1,..., N}}. Here, xₙ denotes an instance value and yₙ may be expressed as a class label yₙ ∈ {1,..., K}.

Since the data set according to an example includes some noise in a real scenario, the apparatus may train the neural network model in consideration of the data set with noise. Here, a label ỹₙ including the potential noise may be expressed as D̃:={(xₙ, ỹₙ); n={1,..., N}}.

Two types of neural network models according to two different types of learning processes may be provided. In one cycle of repeated training, the two models (e.g., the first model and the second model) may be trained in a complementary manner by changing their roles alternately, and after the two models have been trained (e.g., trained the predetermined number of times) they may operate differently.

Non-limiting examples of a method of iterative training described above with reference to FIGS. 1 and 2 and an operation method of a training model obtained through the method are described in detail below.

In the upper flow of FIG. 3, a label correction module 320 may match and temporarily store a temporary label output from a first model 310 to each instance of a data set, and a second model 330 may be trained based on the temporary label of the data set.

According to the lower flow of FIG. 3, based on the labels generated by the second model 330, a noise filtering module 340 may filter the labels output from the second model 330, and may divide all instances of the data set into two groups, a clean data set group comprising clean labels and a data set with noise group comprising noisy labels (e.g., a noisy data set group).

An objective function for identifying clean data from an output result of the second model 330 may be designed as expressed in Equation 1 below, for example.

$$L \left({f}^{m o d e l 2} \left({x}_{i}\right) , {y}_{i}\right) - {E}_{{D}_{Y \left|D\right)}} \left[L \left({f}^{m o d e l 2} \left({x}_{i}\right) , Y\right)\right] \leq 0$$

In Equation 1, (ƒ^{model2}(xᵢ),yᵢ) denotes a loss for a label yᵢ corresponding to an instance xᵢ input to the second model 330, D denotes a data set, and_{D}_{Y|D}[(ƒ^{model2}(xᵢ),Y)] denotes a loss for the data set.

The noise filtering module 340 may detect noise of a label from the result of the second model 330. Data satisfying Equation 1 may be detected as clean data, and data not satisfying Equation 1 may be detected as noise. According to Equation 1, the clean data may be identified according to a size of a difference between the output result of the second model 330 and the label before the label is corrected (e.g., before the label is corrected by the label correction module 320). Thereafter, the clean data may be included in the data set for training the first model 310, and data corresponding to the detected noise may be excluded from the data set for training the first model 310 (e.g., only the clean data may be used to train the first model).

The label correction module 320 may correct a label using a prediction result of the first model 310 (e.g., the trained first model 310). With respect to an input xᵢ (e.g., an input xᵢ of clean data), the first model 310 may output a label ỹᵢ indicating the highest probability among sample classification prediction probabilities. The output label may be used to train the second model 330.

In the following description of an example, a process of training the second model 330 using the output label of the trained first model 310 is described in detail. The first model 310 may calculate an output using a softmax function corresponding to an input instance. The calculated output result of the first model 310 may be used as a temporary label to train the second model 330, and the output result of the first model 310 may be expressed by Equation 2 below, for example.

$${\hat{y}}_{n} = arg max {f}_{{M}_{1}} \left({x}_{n}\right)$$

In Equation 2, ƒ(xₙ) = [ƒ(xₙ) = [ƒ(xₙ)[1],ƒ(xₙ)[2], . . .ƒ(xₙ)[K]] denotes a vector composed of softmax outputs for each class of the first model 310, and ỹₙ denotes a label estimated by the first model 310.

To train the second model 330, a confidence regularization loss along with a standard cross-entropy loss may be used. The confidence regularization loss may be expressed by Equation 3 below, for example.

$${l}_{\text{CR}} \left({f}_{{M}_{2}} \left({x}_{n}\right)\right) : = - {E}_{\hat{Y} \left|\hat{D}\right)} \left[{l}_{\text{CE}} \left({f}_{{M}_{2}} \left({x}_{n}\right) , \hat{Y}\right)\right]$$

In Equation 3, D̂ denotes a data set with a corrected label, Ŷ is the random variable for ŷₙ, and ℓ_{CE}(·,·) denotes a cross-entropy loss. Given the data with the corrected label, may be defined as a conditional expected value of the standard cross-entropy loss function value of the output of the second model 330 and the corrected label. The confidence regularization loss of Equation 3 may be used to provide a penalty for noise fitting and to provide a prediction result with high accuracy.

The total loss of the trained second model 330 may be the sum of the standard cross-entropy loss and the confidence regularization loss as shown in Equation 4 below, for example.

$${L}_{f} : = {\sum }_{n = 1}^{N} {l}_{\text{CE}} \left({f}_{{M}_{2}} \left({x}_{n}\right) , {\hat{y}}_{n}\right) + {\text{λ}}_{f} ⋅ {l}_{\text{CR}} \left({f}_{{M}_{2}} \left({x}_{n}\right)\right)$$

In Equation 4, λ₁ is a hyperparameter for balancing the two terms, and may be determined empirically. The loss expressed by Equation 3 and/or the loss expressed by Equation 4 may be referred to throughout the entire process of training the second model 330.

When the training of the second model 330 is completed, the first model 310 may be trained using the output result of the second model 330 as a label, and the roles of the first model 310 and the second model 330 may be switched (e.g., from training the second model 330 using an output of the first model 310, to training the first model 310 using an output of the second model 330). As described above, in the training of the first model 310, a training target different from that used in the training of the second model 330 may be adopted.

Clean data may be identified using the noise filtering module 340. For example, in a data set, data with noise in the label and clean data may be distinguished. A sample selection function s(n) may be defined and whether the label of an instance is clean or damaged may be determined according to the criterion of Equation 5 below, for example.

$$s \left(n\right) = \left\{\begin{matrix}1 & \text{if ln} \left({f}_{{M}_{2}} \left({x}_{n}\right) \left[{\tilde{y}}_{n}\right]\right) \leq {α}_{n} \\ 0 & \text{otherwise}\end{matrix}\right)$$

Here, ƒₘ₂(·)[i] denotes an i-th element of the softmax function related to an output of the second model 330, and αₙ may be calculated by

$$\frac{1}{K} {\sum }_{y} \text{ln} \left({f}_{{M}_{2}} \left({x}_{n}\right) \left[y\right]\right) .$$

Such criterion is to ensure that clean data is not classified as noise when model predictions are better than random guesses, meaning

$${f}_{{M}_{2}} \left({x}_{n}\right) \left[{\tilde{y}}_{n}\right] > \frac{1}{K} .$$

In order to train the first model 310, when a label of the instance is determined to be clean, a simple cross-entropy loss for the instance may be calculated. In an example of an instance matching a label with noise, the rejection loss function ℓ_{RL} as in Equation 6 below, for example, which is defined as the size of a score corresponding to the corrected label, may be increased.

$${l}_{\text{RL}} \left({f}_{{M}_{1}} \left({x}_{n}\right) , {\tilde{y}}_{n}\right) : = {f}_{{M}_{1}} \left({x}_{n}\right) \left[{\tilde{y}}_{n}\right]$$

Here, ƒ_{M}₁(·)[i] denotes the i-th element of the softmax function output vector f.

The rejection loss may suppress prediction scores for class labels with noise, while allowing a training process to include data with noise in the labels. This may compensate for the lack of training data. The total loss during training of the first model 310 according to an example may be expressed as in Equation 7 below, for example.

$$\begin{matrix}{L}_{b} : = {\sum }_{n = 1}^{N} \left(1 - s \left(n\right)\right) ⋅ {l}_{\text{CE}} \left({f}_{{M}_{1}} \left({x}_{n}\right) , {\tilde{y}}_{n}\right) \\ + {\text{λ}}_{b} ⋅ s \left(n\right) ⋅ {l}_{\text{RL}} \left({f}_{{M}_{1}} \left({x}_{n}\right) , {\tilde{y}}_{n}\right) ,\end{matrix}$$

The first model 310 may be optimized in a corresponding cycle by backpropagating a gradient using the loss function of Equation 6 and/or the loss function of Equation 7 and learning parameters.

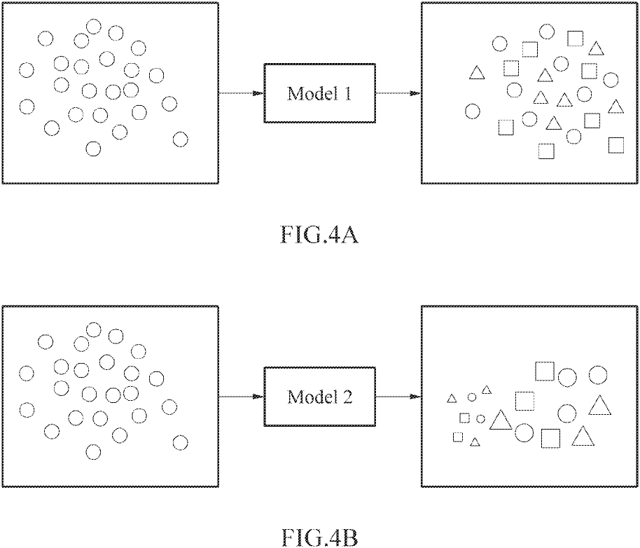

FIGS. 4A and 4B illustrate an example of outputs of a trained first model and a trained second model.

In an iterative training process, the first model (e.g., Model 1 of FIG. 4A) and the second model (e.g., Model 2 of FIG. 4B) may be trained in parallel, but the training methods may be different. FIG. 4(a) shows an output of the first model, and FIG. 4(b) shows an output of the second model.

The first model may be used to infer (e.g., determine) a label. When an instance of a data set including noise in the label is input, a corrected label corresponding to the instance may be output related to the label including noise.

The first model may be utilized to correct noise related to image processing and recognition. For example, when a data set corresponding to a surface normal image and a depth image is input, a depth image from which noise is removed and of which definition is improved may be output through a trained first model.

The second model may be used to detect noise in the label.

In an example related to image processing and recognition, clean data and data with noise may be distinguished in a data set that is input, using the second model. For example, when a loss value of data is large, the data may be detected as noise.

The iterative training method described above may be represented by an algorithm corresponding to Table 1 below, for example.

Through the training of one or mor embodiments of the deep learning model, even when the deep learning model is trained using a data set with many label errors, a label with high accuracy may be obtained.

TABLE 1

Algorithm 1 Iterative Deep Mutual Learning

| | |
|---|---|
| Input: | initial model parameters $\left\{{θ}_{0}^{{M}_{1}} , {θ}_{0}^{{M}_{2}}\right\} ,$ training dataset $\left\{\left({x}_{n} , {\tilde{y}}_{n}\right) ; n ∈ \left\{1 , … , N\right\}\right\}$ |
| Output: | learned model parameters $\left\{{θ}_{T}^{{M}_{1}} , {θ}_{T}^{{M}_{2}}\right\} ,$ |
| for | t = 1,...,T do // FORWARD TRAINING Estimate ŷₙ using (1), (i = 1,...,N). Compute the forward loss L_{ƒ} using (3). ${θ}_{t + 1}^{{M}_{2}} ← {θ}_{t}^{{M}_{2}} - η ⋅ Δ {L}_{f}$ |
| | // BACKWARD TRAINING Estimate s(n) using (4), (i = 1,...,N). Compute the backward loss using (6) ${θ}_{t + 1}^{{M}_{1}} ← {θ}_{t}^{{M}_{1}} - η ⋅ Δ {L}_{b}$ |
| end for | |

In Table 1, FORWARD TRAINING may be a process of training the second model, and BACKWARD TRAINING may be a process of training the first model.

The first model may be used to correct a label of each instance and transmit the corrected label to the second model, and the second model may provide a label in which clean data is distinguished from noise, to the first model. The second model may be trained using the corrected label based on classification performance of the first model.

FIG. 5 illustrates an example of a configuration of an apparatus with label noise processing.

An apparatus 500 may include a processor 510 (e.g., one or more processors), a memory 520 (e.g., one or more memories), and a communication interface 530. The processor 510, the memory 520, and the communication interface 530 may communicate with each other via a communication bus 505.

The processor 510 may perform a method of processing a data set including label noise. The processor 510 may perform any one, any combination, or all of the operations and methods described herein with reference to FIGS. 1-4 and 6.

The method performed by the processor 510 may include repeatedly training a first model for correcting a label of a data set, the label including noise and repeatedly training a second model for detecting the noise of the label, and processing the data set including the noise using at least one of the first model and the second model, wherein the repeated training may include identifying clean data in the data set using the second model, training the first model using the clean data and labels corresponding to each piece of the clean data, correcting the label of the data set using the trained first model, and training the second model based on the corrected data set.

The memory 530 may be a non-transitory computer-readable storage medium (for example, a non-volatile memory). The processor 510 may execute instructions and control the apparatus 500. The instructions executed by the processor 510 may be stored in the memory 530. When the processor 510 executes the instructions, the instructions may configure the processor 510 to control the apparatus 500 and/or perform any one, any combination, or all of the operations and methods described herein with reference to FIGS. 1-4 and 6.

The apparatus 500 may be connected to an external device (e.g., a personal computer (PC) or a network) through an input/output device (not shown) to exchange data therewith. The apparatus 500 may be, or be mounted on, any of various computing devices and/or systems such as a smartphone, a tablet computer, a laptop computer, a desktop computer, a television (TV), a wearable device, a security system, a smart home system, and/or the like.

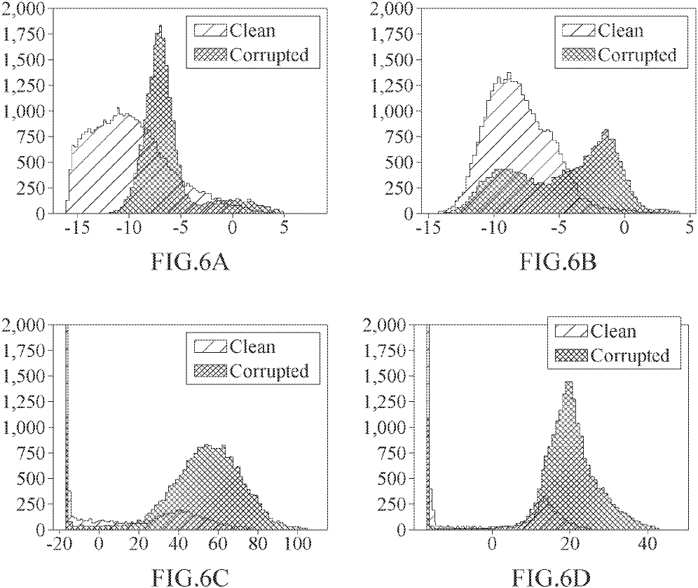

FIGS. 6A-6D are graphs illustrating performance of an apparatus according to examples.

In relation to a data set in which noise is included in the label, FIGS. 6A and 6B are graphs showing a loss distribution of a model trained with a typical cross-entropy loss, which is a result of repeatedly training 30 times and 90 times, respectively, and FIGS. 6C and 6D are graphs showing a loss distribution of a model trained by the method according to one or more embodiments, which is a result of repeatedly training 30 times and 90 times, respectively.

Each of the graphs of FIGS. 6A to 6D shows a histogram of clean data and noise. In the graphs, the x-axis is obtained from a logarithm of a prediction score of the second model, but represents a sample selection criterion, and the y-axis represents the occurrence of a corresponding reference value.

According to FIGS. 6A and 6B, it is necessary to set a predetermined threshold value to distinguish clean data from noise, and even when the threshold value is set, it may be difficult to effectively distinguish clean data.

According to FIGS. 6C and 6D, it can be seen that clean data is easily distinguished from noise compared to the standard cross-entropy loss of FIGS. 6A and 6B. According to the example, the method and apparatus of one or more embodiments may effectively separate clean data and noise having the same threshold value in the vicinity of 0. Since the performance of the second model gradually improves as training is repeated an increasing number of times, the method and apparatus of one or more embodiments may achieve more stable sample filtering, and the training of the first model may be performed stably.

The apparatuses, processors, memories, communication interfaces, communication buses, apparatus 500, processor 510, memory 520, communication interface 530, communication bus 505, and other apparatuses, units, modules, devices, and components described herein with respect to FIGS. 1-6D are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular te“m “proces”or” “r “compu”er” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6D that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, Bd-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented method with label noise processing, the method comprising:
iteratively training a first model for correcting a label of a data set, the label comprising noise, and a second model for detecting the noise of the label; and
processing the data set comprising the noise using either one or both of the trained first model and the trained second model,
wherein the iterative training comprises:
identifying clean data in the data set using the second model;
training the first model using the clean data;
correcting the label of the data set using the trained first model; and
training the second model based on the data set comprising the corrected label.

2. The method of claim 1, wherein the iterative training comprises training the first model and the second model based on the data set.

3. The method of claim 1, wherein the identifying of the clean data in the data set comprises identifying the clean data based on a size of a difference between an output result of the second model and the label before the correcting of the label.

4. The method of claim 3, wherein the identifying of the clean data based on the size of the difference between the output result of the second model and the label before the correcting of the label comprises identifying the clean data based on the following equation:
$$L \left({f}^{m o d e l 2} \left({x}_{i}\right) , {y}_{i}\right) - {E}_{{D}_{Y \left|D\right)}} \left[L \left({f}^{m o d e l 2} \left({x}_{i}\right) , Y\right)\right] \leq 0 ,$$
wherein (ƒ^{model2}(xᵢ), yᵢ) denotes a loss for a label yᵢ corresponding to an input xᵢ input to the second model, D denotes a data set, and D_{Y_{|D}}[(ƒ^{model2}(xᵢ), Y)] denotes a loss for the data set.

5. The method of claim 1, wherein the iterative training of the first model and the second model comprises iteratively training the first model and the second model a predetermined number of times.

6. The method of claim 1, wherein, the identifying of the clean data comprises identifying, in response to the training of the second model based on the data set comprising the corrected label, the clean data in the data set using the trained second model.

7. The method of claim 1, wherein the processing of the data set comprising the noise comprises:
inputting the data set comprising the noise to the trained first model; and
determining a corrected label of the data set corresponding to the noise using the trained first model.

8. The method of claim 1, wherein the processing of the data set comprising the noise comprises:
inputting the data set comprising the noise to the trained second model; and
detecting noise in the data set comprising the noise using the trained second model.

9. The method of claim 1, wherein the data set comprises image data.

10. A non-transitory computer-readable storage medium storing instructions that, when executed by one or more processors, configure the one or more processors to perform the method of claim 1.

11. An apparatus with label noise processing, the apparatus comprising:
one or more processors configured to:
iteratively train a first model for correcting a label of a data set, the label comprising noise and a second model for detecting the noise of the label; and
process the data set comprising the noise using either one or both of the trained first model and the trained second model,
wherein, for the iterative training, the one or more processors are configured to:
identify clean data in the data set using the second model;
train the first model using the clean data and a label corresponding to each piece of the clean data;
correct the label of the data set using the trained first model; and
train the second model based on the data set comprising the corrected label.

12. The apparatus of claim 11, wherein, for the iterative training, the one or more processors are configured to train the first model and the second model based on the data set.

13. The apparatus of claim 11, wherein, for the identifying of the clean data in the data set, the one or more processors are configured to identify the clean data based on a size of a difference between an output result of the second model and the label before the correcting of the label.

14. The apparatus of claim 13, wherein, for the identifying of the clean data based on the size of the difference between the output result of the second model and the label before the correcting of the label, the one or more processors are configured to identify the clean data based on the following equation:
$$L \left({f}^{m o d e l 2} \left({x}_{i}\right) , {y}_{i}\right) - {E}_{{D}_{Y \left|D\right)}} \left[L \left({f}^{m o d e l 2} \left({x}_{i}\right) , Y\right)\right] \leq 0 ,$$
wherein
$$L \left({f}^{m o d e l 2} \left({x}_{i}\right) , {y}_{i}\right)$$
denotes a loss for a label yᵢ corresponding to an input xᵢ, input to the second model, D denotes a data set, and
$${E}_{{D}_{Y \vert D}} \left[L \left({f}^{m o d e l 2} \left({x}_{i}\right) , Y\right)\right]$$
denotes a loss for the data set.

15. The apparatus of claim 11, wherein, for the iterative training of the first model and the second model, the one or more processors are configured to iteratively train the first model for correcting the label and the second model for detecting the noise of the label a predetermined number of times.

16. The apparatus of claim 11, wherein, for the identifying of the clean data comprises identifying, the one or more processors are configured to identify, in response to the training of the second model based on the data set comprising the corrected label, the clean data in the data set using the trained second model.

17. The apparatus of claim 11, wherein, for the processing of the data set comprising the noise, the one or more processors are configured to:
input the data set comprising the noise to the trained second model; and
determining a corrected label of the data set corresponding to the noise using the first trained model.

18. The apparatus of claim 11, wherein, for the processing of the data set, the one or more processors are configured to:
input the data set comprising the noise to the trained second model; and detect noise in the data set comprising the noise using the trained second model.

19. The apparatus of claim 11, wherein the data set comprises image data.

20. The apparatus of claim 11, further comprising a memory storing instructions that, when executed by the one or more processors, configure the one or more processors to perform:
the iteratively training of the first model and the second model; and
the processing of the data set.

21. A processor-implemented method with label noise processing, the method comprising:
identifying clean data in a data set using a second model, the second model being for detecting noise of a label of the data set;
training a first model using the clean data, the first model being for correcting the label;
correcting the label using the trained first model; and
training the second model based on the data set comprising the corrected label.

22. The method of claim 21, wherein the identifying of the clean data comprises:
determining labels of the data set, including the label, using the second model; and
determining the clean data and noisy data of the data set, based on the determined labels.

23. The method of claim 21, further comprising processing the data set comprising the noise using either one or both of the trained first model and the trained second model.
